(19) United States
(12) Patent Application Publication
(10) Pub. No.: US 2022/0414101 A1
(43) Pub. Date: Dec. 29, 2022

(54) SHIFTING LEFT DATABASE DEGRADATION DETECTION

(71) Applicant: Microsoft Technology Licensing, LLC, Redmond, WA (US)

(72) Inventors: Gal TAMIR, Herzliya (IL); Rachel LEMBERG, Herzliya (IL); Raphael FETTAYA, Herzliya (IL)

(21) Appl. No.: 17/357,957

(22) Filed: Jun. 24, 2021

(51) Int. Cl. G06F 16/2453; G06N 20/00

(52) U.S. Cl. CPC G06F 16/24549; G06N 20/00; G06F 8/60

(57) ABSTRACT

Example aspects include techniques for shifting left database degradation detection. These techniques may include identifying a database query in application code in a pre-production environment and predicting, via a prediction model corresponding to a production environment, a resource cost of the database query, the prediction model trained on database activity resulting from execution of a plurality of database queries over a production database system within the production environment. In addition, the techniques may include presenting, via a user interface, a notification corresponding to the resource cost.

### BACKGROUND

Most software applications incorporate a data layer for storing information and providing the information to users and/or services. For example, many applications include database management systems for data persistence. Furthermore, the data layer is often the bottleneck of an application, and may drain system resources with high performance costs. For example, costly database queries may disproportionately consume system resources and deny services to users. To mitigate the effects of poor database performance, system developers may employ query analyzers that provide performance results for database queries. However, traditional query analyzers only detect system degradation from previously-executed database commands and often fail to detect latency degradations in pre-production environments, e.g., development environments.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an aspect, a method may include identifying a database query in application code in a pre-production environment. Further, the method may include predicting, via a prediction model corresponding to a production environment, a resource cost of the database query, the prediction model trained on database activity resulting from execution of a plurality of database queries over a production database system within the production environment, and presenting, via a user interface, a notification corresponding to the resource cost.

In another aspect, a device may include a memory, and at least one processor coupled with the memory and configured to: identify a database query in application code in a pre-production environment, predict, via a prediction model corresponding to a production environment, a resource cost of the database query, the prediction model trained on database activity resulting from execution of a plurality of database queries over a production database system within the production environment, and present, via a user interface, a notification corresponding to the resource cost.

In another aspect, an example computer-readable medium storing instructions for performing the methods described herein and an example apparatus including means of performing operations of the methods described herein are also disclosed.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example environment for shifting left database degradation detection, in accordance with some aspects of the present disclosure.

FIG. 2 is a diagram showing an example environment for shifting left database degradation detection in a cloud computing system, in accordance with some aspects of the present disclosure.

FIG. 3 is a flow diagram showing an example method for shifting left database degradation detection, in accordance with some aspects of the present disclosure.

FIG. 4 is a schematic block diagram of example components of the cloud computing device of FIG. 2, according to aspects of the present disclosure in accordance with some aspects of the present disclosure.

FIG. 5 is a schematic block diagram of example components of the developer device of FIG. 2, according to aspects of the present disclosure in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for shifting left database degradation detection. In particular, aspects of the present disclosure provide a query analyzer service configured to detect database queries within the pre-production environment that may cause performance degradation within a production environment by employing a production based machine learning (ML) model. Accordingly, for example, a system developer may employ the query analyzer service to prevent latency degradation, improve data layer design, and identify problematic database queries without impacting end-users.

In accordance with some aspects of the present disclosure, a query analyzer (e.g., a query analyzer service or query analyzer client) may shift left database degradation detection from a production environment to a pre-production environment by predicting a resource cost within a production environment of a database query from a pre-production environment. For example, a query analyzer may include a ML model that predicts the resource costs for executing a database query in a production environment. As such, the query analyzer may receive database queries from pre-production environments, and employ the ML model to predict whether incorporating the database queries into the production environment will degrade database performance and/or require additional computing resources. For example, the query analyzer may identify database queries from the pre-production environments having resource costs above a pre-configured threshold, and a system developer may replace the identified database queries with less costly database queries. Often system developers are unaware of the effects of a database query until the database query is executed in the production environment as the data layers of pre-production environments vastly differ from the data layer of the production environment. Accordingly, the systems, devices, and methods described herein provide techniques for early detection of resource intensive database queries before implementing the database queries in a production environment in order to prevent database degradation, maximize system performance, and reduce system costs.

### Illustrative Environment

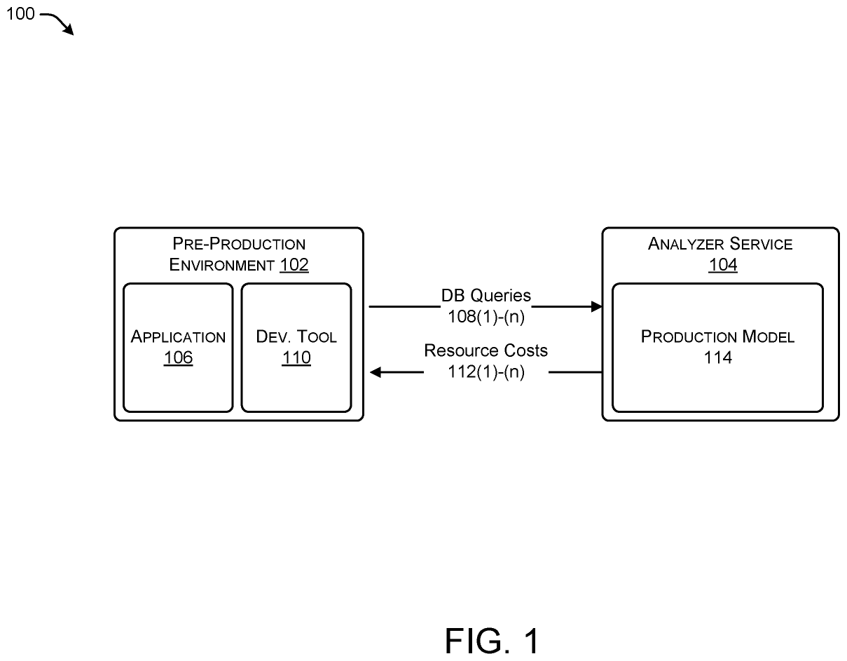

FIG. 1 is a diagram showing an example environment for shifting left database degradation detection within an application system 100, in accordance with some aspects of the present disclosure. As illustrated in FIG. 1, the application system 100 may include a pre-production environment 102 and an analyzer service 104. The pre-production environment 102 may be an environment of any development phase other than the production phase. For example, in a continuous integration and continuous deployment (CI/CD) pipeline, the pre-production environment 102 may be at least one of a coding environment, a development environment, and/or an integration environment. Some other examples of pre-production environments include feature environments, hotfix environments, release environments, quality assurance environments, and staging environments. As used herein, in some aspects, the production environment may refer to an environment where the latest versions of software, products, or updates are pushed live to end-users. Further, as described in detail herein, the production environment may include a production database. As described in detail herein, the production database may include real-world data and may be the largest database out of all the databases within the various environments. In addition, degradation in service within the production environment may affect end-users and trigger expensive auto-scaling or resource allocation.

As illustrated in FIG. 1, the pre-production environment 102 may include an application 106. Some examples of an application include programs, software, web applications, web services, websites, apps, cloud applications, cloud services, back-ends, application programming interface servers, etc. Further, the application 106 within the pre-production environment 102 may be associated with a live application executing within a production environment. For example, the application 106 may be an updated development version of an application executing within a production environment, and include one or more database queries 108 that have been added to the application code within the pre-production environment 102 but not yet incorporated within the application code executing within the production environment.

As described in detail herein, a development tool 110 may transmit the database queries 108(1)-(n) to the analyzer service 104. Upon receipt of a database query 108, the analyzer service 104 may determine resource costs 112(1)-(n) of the database queries 108(1)-(n) based upon a production model 114. For example, the production model 114 may determine a first resource cost 112(1) of a first database query 108(1), a second resource cost 112(2) of a second database query 108(2), an nth resource cost 112(n) of the nth database query 108(n), and so forth. As another example, a plurality of resources costs 112(1)-(n) may correspond to a single database query 108(1). In some aspects, the production model 114 may be a ML model configured to determine a resource cost representing an expected consumption of one or more resources (e.g., a cloud computing resource) resulting from execution of a database query 108 over a database system in the production environment. Some examples of a resource cost include runtime (i.e., elapsed time during performance of the query), computer processing unit (CPU) utilization, memory utilization, and/or input/output (I/O) utilization.

Once the analyzer service 104 determines the resource cost 112, the analyzer service 104 may present the resource cost 112 to a system developer via a user interface. For example the analyzer service 104 may transmit the resource cost 112 to the development tool 110, and the development tool 110 may provide a notification to the system developer indicating the resource cost 112 of executing the database query 108 within the production environment (e.g., a textual notification including the resource cost 112). In some aspects, the development tool 110 may only notify the system developer of the resource cost 112 when the resource cost 112 is above a predefined threshold. Accordingly, the analyzer service 104 may be employed to identify database queries 108(1)-(n) within a pre-production environment 102 that may cause degradation and bottlenecks within the corresponding production environment during a pre-production phase of application development.

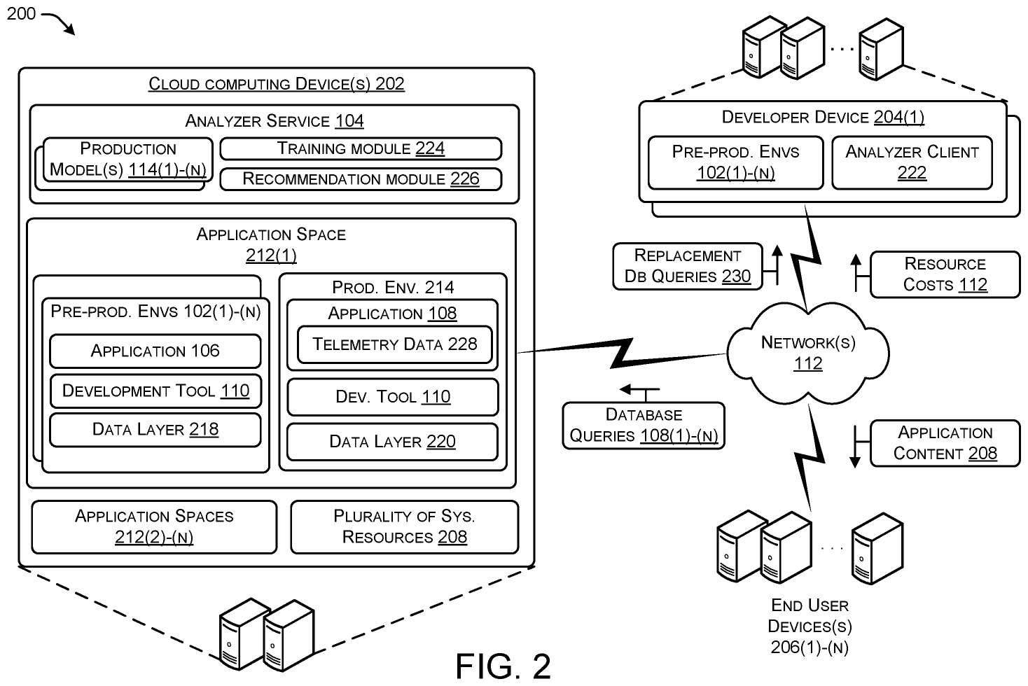

FIG. 2 is a diagram showing an example environment for shifting left database degradation detection in cloud computing system 200, in accordance with some aspects of the present disclosure. As illustrated in FIG. 2, the cloud computing system 200 may include a cloud computing device 202, one or more developer devices 204, and one or more end-user devices 206. The cloud computing device 202 may provide distributed storage and access to software, services, files, and/or data via a network, e.g., the Internet. Further, in some aspects, the cloud computing device 202 may provide a multi-tenancy environment wherein one or more system resources 208 of the cloud computing device 202 are shared among application developers but individual data associated with each application developer is logically separated. As described herein, the application developers may be customers of the operator of the cloud computing device 202. Further, the application developers may have relationships with one or more end-users, and provide one or more digital services to the end-users devices 206(1)-(N) associated with the end-users via the cloud computing device 202. As an example, the application developer may operate an application 106, and an end-user may be a subscriber to the application 106. In addition, the application developer may employ the cloud computing device 202 to provide components of the application 106 to the end-user device 206(1) associated with the subscriber. For instance, the application developer may configure the cloud computing device 202 to transmit application content 210 to the end-user device 206(1). Some examples of the end-user devices 206 include smartphones and computing devices, Internet of Things (IoT) devices, video game systems, robots, process automation equipment, sensors, control devices, vehicles, transportation equipment, virtual and augmented reality (VR and AR) devices, industrial machines, etc.

The cloud computing device 202 may include the analyzer service 104 and application spaces 212(1)-(n). Each application space 212 may include one or more pre-production environments 102(1)-(n) and a production environment 214. In some aspects, an application 106 may have a pre-production environment 102 for each stage of development and/or deployment of the application 106 prior to production. For example, the pre-production environment 102(1) may be a coding environment for updating the application code of the application 106, the pre-production environment 102(2) may be a testing environment for testing updates to the application code of the application 106, and the pre-production environment 102(3) may be an integration environment for integration testing of updates to the application code of the application 106. Further, a pre-production environment 102 may include a version of the application 106, a development tool 110, and a data layer 218. As used herein, in some aspects, a “development tool” may correspond to an application or script employed during the software development process. Some examples of development tools include integrated development environments (IDEs), testing suites, testing tools, deployments tools, build tools, analytics tools, etc. For example, the pre-production environment 102(1) may be a coding environment and the development tool 110 may include an IDE, and the pre-production environment 102(2) may be a testing environment and the development tool 110 may include a testing suite. In addition, the data layer 218 may be configured to provide data access to the application 106 in the shared environment. For example, the data layer 218(1) of the pre-production environment 102(1) may provide data access to the application 106 within the pre-production environment 102(1). Further, the data layer 220 may be a mock database or lightweight database, e.g., an in-memory database, having less capabilities, and/or data than the data layer 220 within the production environment 214.

The production environment 214 may include the live version of the application 106, a development tool 110, and the data layer 220. Further, the data layer 220 within the production environment 214 may provide data access to the live version of the application 106 executing within the production environment 214. In addition, as described herein, the analyzer service 104 may detect potentially harmful database queries 108 within one of the pre-production environments 102 of the application space 212 before the harmful database queries are executed by the live version of the application 106 over the data layer 220 and negatively impact usage of the system resources 208 and/or provision of the application content 210 to the end-user devices 206. Further, the analyzer service 104 may employ the production models 114(1)-(n) to detect the potentially harmful database queries 108.

As illustrated in FIG. 2, a developer device 204 may also include one or more pre-production environments 102(1)-(n) and an analyzer client 222. For example, a developer device 204(1) may include the pre-production environment 102(1) for updating the application code of the application 106. In addition, the analyzer client 222 may provide some or all of the functionality of the analyzer service 104. For example, the analyzer client 222 may act as a front-end component to the analyzer service 104 that transmits database queries 108 to the analyzer service 104, and presents the resource costs 112(1)-(n) received from the analyzer service 104 to a system developer via a graphical user interface (GUI). In another example, the analyzer client 222 may include the production model 114. Further, the local copy of the production model 114 may receive the database queries 108(1)-(n), determine the resource costs 112(1)-(n) of the database queries 108(1)-(n), and present the resource costs 112(1)-(n) via a GUI. In addition, the analyzer service 104 may manage and/or update the local copy of the production model 114 within the analyzer client 222.

As illustrated in FIG. 2, the analyzer service 104 may include the production models 114(1)-(n), a training module 224, and a recommendation module 226. In some aspects, the analyzer service 104 may be configured to receive a request for one or more resource costs 112 of a database query 108 from a development tool 110, and transmit the resource costs 112 to the development tool 110. Additionally, in some aspects, the analyzer service 104 may include a web portal that receives a database query 108 via a user interface, and displays the resource costs 112(1)-(n) for the database query 108 within the user interface. In some other aspects, the analyzer service 104 may be a component (e.g., plug-in component) or feature of a development tool 110. For example, in some aspects, the analyzer service 104 may be a component of an IDE or testing suite. Further, in some aspects, the development tool 110 may be configured to determine a degradation context based on one or more resource costs 112, and prevent deployment of the application code of a first pre-production environment (e.g., pre-production environment 102(1)) to a second pre-production environment (e.g., pre-production environment 102(1)) following the first pre-production environment 102(1) in a development pipeline (e.g., CI/CD pipeline) based on the degradation context. For example, an IDE in the first pre-production environment 102(1) may determine that a resource cost 112 for executing a database query 108 in the production environment 214 exceeds a predefined threshold. As a result, the IDE may present a visual notification indicating that the IDE has blocked deployment of the application code of the application 106 within the pre-production environment 102(1) to a testing tool (e.g., a unit testing tool, an integration testing tool, etc.) of another pre-production environment 102(2).

As described herein, the analyzer service 104 may employ the production models 114(1)-(n) to determine the resource costs 112(1)-(n). In particular, the production models 114(1)-(n) may be configured to predict a resource costs 112(1)-(n) of executing a database query 108 within the production environment 214. In some aspects, each application 106 may have an individual production model 114. For example, the first application 106(1) may have a first production model 114(1), the nth application 106 may have an nth production model 114(1), and so forth. Accordingly, the production model 114(1) may be configured to determine the resource costs 112 of executing a database query 108 over the data layer 220.

In some aspects, a production model 114 may be at least one of a natural language processing ML model, a decision tree ML model, a tree-based learning ML model, a random forest ML model, etc. Further, the production models 114 may be query—language agnostic and configured to determine the resource costs 112 of database queries 108 written in any query language. Additionally, the production models 114(1)-(n) may be configured to apply an attention learning mechanism that determines relationships between individual terms within a database query 108 when determining the resource costs 112(1)-(n) of a database query 108. For example, in some aspects, the production model 114 may be configured to identify a relationship between two or more operators within a database query 108.

Further, the training module 224 may be configured to generate the production models 114(1)-(n). In some aspects, the training module 224 may train the production models 114(1)-(n) based on query text and telemetry data 228 received from the production environment 214 of each application space 212. For example, the application 106 within the production environment 214 may execute a database query 108 over the data layer 220 and collect telemetry data 228 corresponding to the costs to the system resources 208 for executing the database query 108. Some examples of the telemetry data 228 may include elapsed time during performance of the query, CPU usage during performance of the database query 108, I/O usage during performance of the database query 108, and any other resource consumption during performance of the database query 108. In addition, the application 106 may transmit a query string (i.e., the text of the database query 108) and the corresponding telemetry data 228 to the training module 224. Further, the training module 224 may train and/or update the production model 114(1) corresponding to the application 106(1) using the query strings and telemetry data 228 for a plurality of database queries 108(1)-(n) executed over the data layer 220. The plurality of database queries 108(1)-(n) may be in different query languages, thereby enabling the production model 114 generated by the training module 224 to be query language agnostic. As described herein, using the production models 114 to detect expensive database queries 108 permits a system developer to shift left detection of database degradation in a production environment 214 from the production environment 214 to a pre-production environments 102.

Further, in some aspects, the training module 224 may identify other applications 106 and/or data layers 220 in other production environments 214 that are similar to the application 106 and the data layer 220, and train and/or update the production model 114(1) based on the telemetry data 228 received from the other applications 106 and/or data layers 220. For example, the training module 224 may generate a distance value defining a relationship between the data layer 220(1) of application 106(1) and the data layer 220(2) of another application 106(1), and employ the telemetry data 228 of the other application 106(2) to train and/or update the production model 114(1) for the application 106(1) when the distance value is lower than a predefined threshold. In some aspects, the distance value may measure similarities between the attributes of the data layers 220 (e.g., database size, database type (e.g., structured query language (SQL) databases, no-SQL databases of the data layers, query language type, service level requirements, etc.) and/or content of the data layers 220 (e.g., table names, data types, etc.). In some examples, the analyzer client 222 may include at least a portion of the production model 114. As such, once the training module 224 has trained and/or updated a production model 114 of an application 106, the training module 224 may transmit the updated production model 114 to the analyzer client 222.

In addition, the recommendation module 226 may be configured to recommend replacement database queries 230 to an application developer for incorporation into the application code of the application 106 within the production environment 214. For example, if the production model 114 determines that a database query 108 may cause a degradation context within the production environment 114, i.e., have one or more resource costs 112 above a predefined threshold (e.g., a CPU utilization above 20%), the recommendation module 226 may recommend a functionally equivalent database query having a lower resource cost to replace the database query 108 within the application code within the pre-production environment 102. In some aspects, the recommendation module 226 may be configured to monitor developer activity, identify when expensive database queries 108 that are predicted to cause a degradation context are replaced, and identify the replacement database queries used to replace the expensive database queries 108. Further, the recommendation module 226 may employ ML or pattern recognition techniques to recommend a replacement database query 230 based on the identified expensive database queries. In some aspects, the recommendation module 226 may determine the replacement database queries 230(1)-(n) based on other applications 106 and/or data layers 220 in a production environment 214 that are similar to the application 106(1) and the data layer 220(1). For example, the training module 224 may generate a distance value defining a relationship between the data layer 220(1) of application 106(1) and the data layer 220(2) of another application 106(1), and employ the developer activity of the other application for recommending replacement database queries 230(1)-(n) when the distance value is lower than a predefined threshold.

Suppose an application developer modifies the application code of the application 106(1) within a development tool 110 (e.g., an IDE) in the pre-production environment 102(1) (i.e., a development environment). The development tool 110 may identify one or more database queries 108 within the application code before or after compilation of the application code, transmit the one or more database queries 108 to the analyzer service 104, and receive the resources costs 112(1)-(n) of the database queries 108 over the data layer 220 as determined by the production model 114(1). Additionally, the development tool 110 may present the resource costs 112 to the application developer within a GUI. In some aspects, the development tool 110 and/or production model 114(1) may identify expensive database queries that degrade the data layer 220 or otherwise negatively affect the production environment 114(1). Further, the development tool 110 may recommend replacement database queries 230(1)-(n) to substitute for the expensive database queries that have been determined by the recommendation module 226.

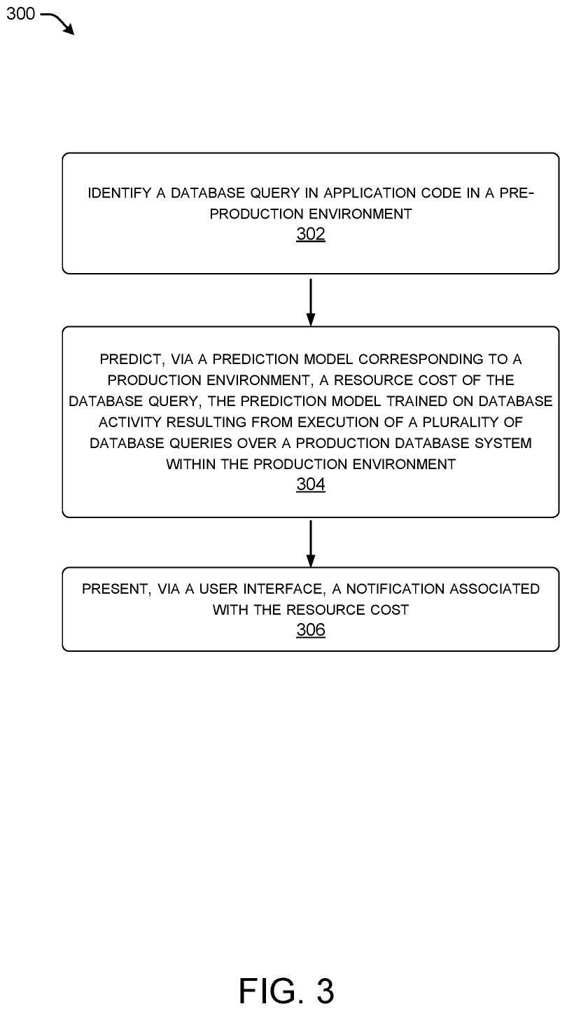

FIG. 3 is a flow diagram showing an example method 300 for performing differential overbooking, in accordance with some aspects of the present disclosure.

At block 302, the method 300 may include identifying a database query in application code in a pre-production environment. For example, the analyzer service 104 and/or the analyzer client 222 may receive a database query 108 from a development tool 110, e.g., an IDE or testing suite. In some aspects, a development tool 110 may identify a database query 108 within the application code for the application 106 within a pre-production environment 102(1), and transmit the database query 108 to the analyzer service 104 and/or the analyzer client 222.

Accordingly, the cloud computing device 202 or the processor 402 executing the analyzer service 104 may provide means for identifying a database query in application code in a pre-production environment. In addition, the developer device 204 or the processor 502 executing the analyzer client 222 may provide means for identifying a database query in application code in a pre-production environment.

At block 304, the method 300 may include predicting, via a prediction model corresponding to a production environment, a resource cost of the database query, the prediction model trained on database activity resulting from execution of a plurality of database queries over a production database system within the production environment. For example, the analyzer service 104 and/or the analyzer client 222 may employ the production model 114 to determine a resource cost 112 of executing the database query 108 over the data layer 220 within the production environment 214.

Accordingly, the cloud computing device 202 or the processor 402 executing the analyzer service 104 may provide means for predicting, via a prediction model corresponding to a production environment, a resource cost of the database query, the prediction model trained on database activity resulting from execution of a plurality of database queries over a production database system within the production environment. In addition, the developer device 204 or the processor 502 executing the analyzer client 222 may provide means for predicting, via a prediction model corresponding to a production environment, a resource cost of the database query, the prediction model trained on database activity resulting from execution of a plurality of database queries over a production database system within the production environment.

At block 306, the method 300 may include presenting, via a user interface, a notification corresponding to the resource cost. For example, the analyzer service 104 and/or the analyzer client 222 may transmit the resource cost 112 to a development tool 110, and cause the development tool to display the resource cost 112 via a user interface.

Accordingly, the cloud computing device 202, or the processor 402 executing the analyzer service 104 may provide means for presenting, via a user interface, a notification corresponding to the resource cost. In addition, the developer device 204 or the processor 502 executing the analyzer client 222 may provide means for presenting, via a user interface, a notification corresponding to the resource cost.

Additionally, or alternatively, in some aspects, the analyzer service 104 may receive a query string corresponding to a database query 108 via a user interface of a web portal, determine the resource cost 112 of the database query 108 via the production model 114, and display the resource cost 112 via the user interface of the web portal. Accordingly, the cloud computing device 202 or the processor 402 executing the analyzer service 104 may provide means for receiving a query string corresponding to a database query 108 via a user interface of a web portal, determining the resource cost 112 of the database query 108 via the production model 114, and displaying the resource cost 112 via the user interface of the web portal.

While the operations are described as being implemented by one or more computing devices, in other examples various systems of computing devices may be employed. For instance, a system of multiple devices may be used to perform any of the operations noted above in conjunction with each other.

### Illustrative Computing Devices

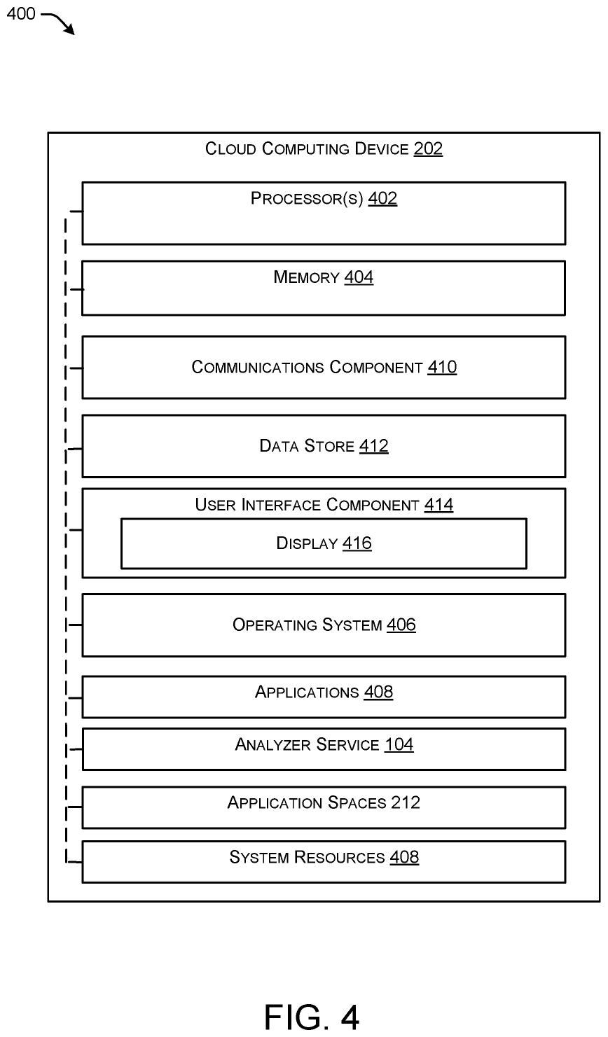

Referring now to FIG. 4, an example 400 of the cloud computing device 202 in accordance with an implementation includes additional component details as compared to FIG. 2. In one example, the cloud computing device 202 includes the processor 402 for carrying out processing functions associated with one or more of components and functions described herein. The processor 402 can include a single or multiple set of processors or multi-core processors. Moreover, the processor 402 may be implemented as an integrated processing system and/or a distributed processing system. In an example, the processor 402 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 402 may include other processing components such as one or more arithmetic logic units (ALUs), registers, or control units.

In an example, the cloud computing device 202 also includes the memory 404 for storing instructions executable by the processor 402 for carrying out the functions described herein. The memory 404 may be configured for storing data and/or computer-executable instructions defining and/or associated with the operating system 406, analyzer service 104, production models 114(1)-(n), training module 224, recommendation module 226, application spaces 212(1)-(n), pre-production environments 102(1)-(n), applications 106, development tools 110, data layers 218 and 220, one or more applications 408, and the processor 402 may execute the operating system 406, analyzer service 104, training module 224, recommendation module 226, application spaces 212(1)-(n), pre-production environments 102(1)-(n), applications 106, development tools 110, and/or the one or more applications 408. An example of memory 404 may include, but is not limited to, a type of memory usable by a computer, such as random access memory (RAM), read only memory (ROM), tapes, magnetic discs, optical discs, volatile memory, non-volatile memory, and any combination thereof. In an example, the memory 404 may store local versions of applications being executed by processor 402.

The example cloud computing device 202 also includes a communications component 410 that provides for establishing and maintaining communications with one or more parties utilizing hardware, software, and services as described herein. The communications component 410 may carry communications between components on the cloud computing device 202, as well as between the cloud computing device 202 and external devices, such as devices located across a communications network and/or devices serially or locally connected to the cloud computing device 202. For example, the communications component 410 may include one or more buses, and may further include transmit chain components and receive chain components associated with a transmitter and receiver, respectively, operable for interfacing with external devices. In an implementation, for example, the communications component 410 may include a connection to communicatively couple the tenant devices 104(1)-N) or the client devices 108(1)-(N) to the processor 402.

The example cloud computing device 202 also includes a data store 412, which may be any suitable combination of hardware and/or software, that provides for mass storage of information, databases, and programs employed in connection with implementations described herein. For example, the data store 412 may be a data repository for the operating system 406 and/or the applications 408.

The example cloud computing device 202 also includes a user interface component 414 operable to receive inputs from a user of the cloud computing device 202 and further operable to generate outputs for presentation to the user. The user interface component 414 may include one or more input devices, including but not limited to a keyboard, a number pad, a mouse, a touch-sensitive display (e.g., display 416), a digitizer, a navigation key, a function key, a microphone, a voice recognition component, any other mechanism capable of receiving an input from a user, or any combination thereof. Further, the user interface component 414 may include one or more output devices, including but not limited to a display (e.g., display 416), a speaker, a haptic feedback mechanism, a printer, any other mechanism capable of presenting an output to a user, or any combination thereof.

In an implementation, the user interface component 414 may transmit and/or receive messages corresponding to the operation of the operating system 406 and/or the applications 408. In addition, the processor 402 executes the operating system 406 and/or the applications 408, and the memory 404 or the data store 412 may store them.

Further, one or more of the subcomponents of the analyzer service 104, production models 114(1)-(n), training module 224, recommendation module 226, application spaces 212(1)-(n), pre-production environments 102(1)-(n), applications 106, development tools 110, and/or data layers 218 and 220, may be implemented in one or more of the processor 402, the applications 408, the operating system 406, and/or the user interface component 414 such that the subcomponents of the analyzer service 104, production models 114(1)-(n), training module 224, recommendation module 226, application spaces 212(1)-(n), pre-production environments 102(1)-(n), applications 106, development tools 110, and/or data layers 218 and 220, are spread out between the components/subcomponents of the cloud computing device 202.

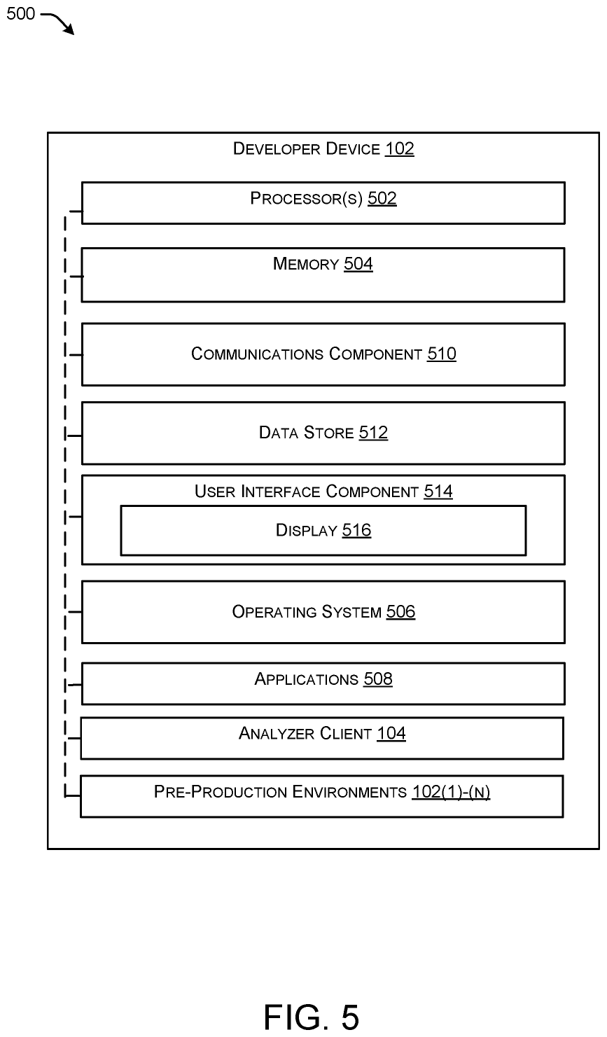

Referring now to FIG. 5, an example 500 of the developer device 204 in accordance with an implementation includes additional component details as compared to FIG. 2. In one example, the developer device 204 includes the processor 502 for carrying out processing functions associated with one or more of components and functions described herein. The processor 502 can include a single or multiple set of processors or multi-core processors. Moreover, the processor 502 may be implemented as an integrated processing system and/or a distributed processing system. In an example, the processor 502 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 502 may include other processing components such as one or more arithmetic logic units (ALUs), registers, or control units.

In an example, the developer device 204 also includes the memory 504 for storing instructions executable by the processor 502 for carrying out the functions described herein. The memory 504 may be configured for storing data and/or computer-executable instructions defining and/or associated with the operating system 506, pre-production environments 102(1)-(n), application 106, development tools 110, data layers 218, production model 114, analyzer client 222, one or more applications 508, and the processor 502 may execute the operating system 506, pre-production environments 102(1)-(n), analyzer client 222, application 106, development tools 110, and/or the one or more applications 508. An example of memory 504 may include, but is not limited to, a type of memory usable by a computer, such as random access memory (RAM), read only memory (ROM), tapes, magnetic discs, optical discs, volatile memory, non-volatile memory, and any combination thereof. In an example, the memory 504 may store local versions of applications being executed by processor 502.

The example developer device 204 also includes a communications component 510 that provides for establishing and maintaining communications with one or more parties utilizing hardware, software, and services as described herein. The communications component 510 may carry communications between components on the developer device 204, as well as between the developer device 204 and external devices, such as devices located across a communications network and/or devices serially or locally connected to the developer device 204. For example, the communications component 510 may include one or more buses, and may further include transmit chain components and receive chain components associated with a transmitter and receiver, respectively, operable for interfacing with external devices. In an implementation, for example, the communications component 510 may include a connection to communicatively couple the tenant devices 104(1)-N) or the client devices 108(1)-(N) to the processor 502.

The example developer device 204 also includes a data store 512, which may be any suitable combination of hardware and/or software, that provides for mass storage of information, databases, and programs employed in connection with implementations described herein. For example, the data store 512 may be a data repository for the operating system 506 and/or the applications 508.

The example developer device 204 also includes a user interface component 514 operable to receive inputs from a user of the developer device 204 and further operable to generate outputs for presentation to the user. The user interface component 514 may include one or more input devices, including but not limited to a keyboard, a number pad, a mouse, a touch-sensitive display (e.g., display 516), a digitizer, a navigation key, a function key, a microphone, a voice recognition component, any other mechanism capable of receiving an input from a user, or any combination thereof. Further, the user interface component 514 may include one or more output devices, including but not limited to a display (e.g., display 516), a speaker, a haptic feedback mechanism, a printer, any other mechanism capable of presenting an output to a user, or any combination thereof.

In an implementation, the user interface component 514 may transmit and/or receive messages corresponding to the operation of the operating system 506 and/or the applications 508. In addition, the processor 502 executes the operating system 506 and/or the applications 508, and the memory 504 or the data store 512 may store them.

Further, one or more of the subcomponents of the pre-production environments 102(1)-(n), application 106, development tools 110, data layers 218, production model 114, and/or analyzer client 222 may be implemented in one or more of the processor 502, the applications 508, the operating system 506, and/or the user interface component 514 such that the subcomponents of the pre-production environments 102(1)-(n), application 106, development tools 110, data layers 218, production model 114, and/or analyzer client 222 are spread out between the components/subcomponents of the developer device 204.

### CONCLUSION

In closing, although the various embodiments have been described in language specific to structural features and/or methodological acts, it is to be understood that the subject matter defined in the appended representations is not necessary limited to the specific features or acts described. Rather, the specific features and acts are disclosed as example forms of implementing the claimed subject matter.

What is claimed is:

1. A device comprising:
a memory storing instructions; and
at least one processor coupled with the memory and configured to execute the instructions to:
identify a database query in application code in a pre-production environment;
predict, via a prediction model corresponding to a production environment, a resource cost of the database query, the prediction model trained on database activity resulting from execution of a plurality of database queries over a production database system within the production environment; and
present, via a user interface, a notification corresponding to the resource cost.

2. The device of claim 1, wherein the database query is an original database query, the resource cost is a first resource cost, and the at least one processor is further configured to:
collect user activity associated with replacing the original database query or a related database query, the user activity corresponding to one or more applications having a shared attribute with the application code;
determine, based on the user activity, a recommended database query having a second resource cost lower than the first resource cost; and
present, via the user interface, a notification associated with the recommended database query.

3. The device of claim 1, wherein the database activity includes a plurality of resource costs corresponding to the plurality of database queries, and the at least one processor is further configured to train the production model based on the plurality of resource costs.

4. The device of claim 1, wherein the plurality of database queries are in different query languages.

5. The device of claim 1, wherein the at least one processor is further configured to:
determine a degradation context based on the resource cost, and prevent deployment of the application code to an environment following the pre-production environment in a development pipeline based on the degradation context.

6. The device of claim 1, wherein to identify the database query in the application code in the pre-production environment, the at least one processor is configured to receive a selection of the database query via a graphical user interface of an integrated development environment.

7. The device of claim 1, wherein the pre-production environment is at least one of a coding environment, development environment, or an integration environment.

8. The device of claim 1, wherein the resource cost includes at least one of runtime, computer processing unit (CPU) utilization, and/or memory utilization.

9. A method of resource allocation for wireless communication at a base station, comprising:
identifying a database query in application code in a pre-production environment;
predicting, via a prediction model corresponding to a production environment, a resource cost of the database query, the prediction model trained on database activity resulting from execution of a plurality of database queries over a production database system within the production environment; and
presenting, via a user interface, a notification corresponding to the resource cost.

10. The method of claim 9, wherein the database query is an original database query, the resource cost is a first resource cost, and further comprising:
collecting user activity associated with replacing the original database query or a related database query, the user activity corresponding to one or more applications having a shared attribute with the application code;
determining, based on the user activity, a recommended database query having a second resource cost lower than the first resource cost; and
presenting, via the user interface, a notification associated with the recommended database query.

11. The method of claim 9, wherein the database activity includes a plurality of resource costs corresponding to the plurality of database queries, further comprising training the production model based on the plurality of resource costs.

12. The method of claim 9, wherein the plurality of database queries are in different query languages.

13. The method of claim 9, further comprising determining a degradation context based on the resource cost, and preventing deployment of the application code to an environment following the pre-production environment in a development pipeline based on the degradation context.

14. The method of claim 9, wherein identifying the database query in the application code in the pre-production environment comprises receiving a selection of the database query via a graphical user interface of an integrated development environment.

15. The method of claim 9, wherein the pre-production environment is at least one of a coding environment, development environment, or an integration environment.

16. A non-transitory computer-readable device having instructions thereon that, when executed by at least one computing device, causes the at least one computing device to perform operations comprising:
identifying a database query in application code in a pre-production environment;
predicting, via a prediction model corresponding to a production environment, a resource cost of the database query, the prediction model trained on database activity resulting from execution of a plurality of database queries over a production database system within the production environment; and
presenting, via a user interface, a notification corresponding to the resource cost.

17. The non-transitory computer-readable device of claim 16, wherein the database query is an original database query, the resource cost is a first resource cost, and the operations further comprise:
collecting user activity associated with replacing the original database query or a related database query, the user activity corresponding to one or more applications having a shared attribute with the application code;
determining, based on the user activity, a recommended database query having a second resource cost lower than the first resource cost; and
presenting, via a user interface, a notification associated with the recommended database query.

18. The non-transitory computer-readable device of claim 16, wherein the operations further comprise:
determining a degradation context based on the resource cost, and preventing deployment of the application code to an environment following the pre-production environment in a development pipeline based on the degradation context.

19. The non-transitory computer-readable device of claim 16, wherein identifying the database query in application code in the pre-production environment comprises receiving text input of the database query via a user interface of web portal.

20. The non-transitory computer-readable device of claim 16, wherein the resource cost includes at least one of runtime, computer processing unit (CPU) utilization, and/or memory utilization.
